(19) United States
(12) Patent Application Publication
(10) Pub. No.: US 2010/0082365 A1
(43) Pub. Date: Apr. 1, 2010

(54) Navigation and Visualization of Multi-Dimensional Image Data

(75) Inventors: Allan Noordvyk, Surrey (CA); Radu Catalin Bocirnea, New Westminster (CA); Leonard Yan, Burnaby (CA)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited

(21) Appl. No.: 12/242,956

(22) Filed: Oct. 1, 2008

(51) Int. Cl. G06Q 50/00; G06K 9/00

(52) U.S. Cl. 705/2; 382/128

(57) ABSTRACT

An apparatus, method, and computer program product are provided for navigating, analyzing, annotating, and interpreting images. The apparatus may receive medical images comprising a volume, identify a display protocol (for the medical volumes) that comprises one or more configurable and editable stages, and execute the display protocol using at least a portion of the medical volumes.

### BACKGROUND OF THE INVENTION

Currently, the health care industry benefits from medical imaging, which is often used by medical professionals to generate images of the human body or one or more parts of the human body for clinical purposes such as diagnosing a patient's medical condition. Oftentimes, medical professionals navigate, analyze, annotate, and interpret various images from one or more studies related to a particular patient to aid in the diagnosis or prognosis of the patient's medical condition. And although technology allows for some of these steps to be performed automatically (e.g., identifying chambers of the heart), many steps still require human interaction to navigate and/or manipulate images before they can be interpreted. Additionally, many of the steps (automatic and/or manual) are repeated (or at least similar) each time a medical professional interprets the images of a particular case type, e.g., interpreting a case of an enlarged atrium of a patient's heart. Thus, efficiency could be increased if the sequence of steps were predefined to (1) automatically perform some steps and (2) guide a medical professional through other manual steps. In addition to increasing the efficiency of medical professionals, this would reduce the skill-level and training necessary to interpret particular cases because medical professionals could be guided through the interpretation of a particular case type.

To that end, it would be desirable to provide for the ability to create configurable workflows for interpreting images. Moreover, it would be beneficial if portions of each workflow could be added, edited, and/or deleted before, during, and/or after execution of the workflow. This would provide medical professionals with configurable, editable workflows for performing certain steps automatically and guiding medical professionals through steps that require human involvement.

### BRIEF SUMMARY OF THE INVENTION

In general, embodiments of the present invention provide systems and methods to navigate, analyze, annotate, and interpret various images, e.g., medical images of the human body or one or more parts of the human body. In particular, a display protocol (that can be edited before, during, and/or after execution) comprising one or more stages of manual, automated, and mixed functionality can be executed to guide a user in interpreting images.

In accordance with one aspect, a first computer-implemented method is provided, which, in one embodiment, may include: electronically receiving one or more medical volumes corresponding to an anchor study; electronically classifying each of the one or more medical volumes corresponding to the anchor study; electronically identifying, via a computing device, a display protocol from a plurality of display protocols, wherein the display protocol: comprises one or more stages, and is configurable to (a) edit, (b) delete, or (c) add one or more stages during execution of the display protocol in response to an input from a user; electronically executing, via the computing device, the display protocol using at least a portion of the one or more medical volumes corresponding to the anchor study; causing display of at least a portion of the one or more medical volumes corresponding to the anchor study; electronically receiving, via the computing device, an input from a user to edit at least one stage of the one or more stages of the display protocol; and electronically editing, via the computing device, the at least one stage of the one or more stages of the display protocol.

In accordance with another aspect, a second computer-implemented method is provided, which, in one embodiment, may include: electronically receiving one or more medical volumes corresponding to an anchor study; electronically identifying, via a computing device, a display protocol from a plurality of display protocols, wherein the display protocol: comprises one or more stages, and is configurable to (a) edit, (b) delete, or (c) add one or more stages during execution of the display protocol in response to an input from a user; electronically executing, via the computing device, the display protocol using at least a portion of the one or more medical volumes corresponding to the anchor study; and causing display of at least a portion of the one or more medical volumes corresponding to the anchor study.

In another aspect, an apparatus comprising one or more processors is provided. In one embodiment, the processor may be configured to electronically receive one or more medical volumes corresponding to an anchor study and to electronically identify a display protocol from a plurality of display protocols, wherein the display protocol: comprises one or more stages, and is configurable to (a) edit, (b) delete, or (c) add one or more stages during execution of the display protocol in response to an input from a user. In this embodiment, the one or more processors of the apparatus may also be configured to electronically execute the display protocol using at least a portion of the one or more medical volumes corresponding to the anchor study; and cause display of at least a portion of the one or more medical volumes corresponding to the anchor study.

In still yet another aspect, a computer program product is provided, which contains at least one computer-readable storage medium having computer-readable program code portions stored therein. The computer-readable program code portions of one embodiment may include: a first executable portion configured to receive one or more medical volumes corresponding to an anchor study; a second executable portion configured to identify a display protocol from a plurality of display protocols, wherein the display protocol: comprises one or more stages, and is configurable to (a) edit, (b) delete, or (c) add one or more stages during execution of the display protocol in response to an input from a user; a third executable portion configured to execute the display protocol using at least a portion of the one or more medical volumes corresponding to the anchor study; and a fourth executable portion configured to cause display of at least a portion of the one or more medical volumes corresponding to the anchor study.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an overview of one embodiment of a system that can be used to practice aspects of the present invention.

FIG. 2 shows exemplary types of images that can be used by embodiments of the present invention.

FIG. 3 shows an image that can be used by embodiments of the present invention.

FIGS. 4-8 show flowcharts illustrating operations and processes that can be used in accordance with various embodiments of the present invention.

FIGS. 9-12 show universal input and output produced by one embodiment of the invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Methods, Apparatus, Systems, and Computer Program Products

As should be appreciated, the embodiments may be implemented as methods, apparatus, systems, or computer program products. Accordingly, the embodiments may take the form of an entirely hardware embodiment, an entirely software embodiment, or an embodiment combining software and hardware aspects. Furthermore, the various implementations may take the form of a computer program product on a computer-readable storage medium having computer-readable program instructions (e.g., computer software) embodied in the storage medium. More particularly, implementations of the embodiments may take the form of web-implemented computer software. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, can be implemented by computer program instructions, e.g., as logical steps or operations. These computer program instructions may be loaded onto a general purpose computer, special purpose computer, or other programmable data processing apparatus to produce a machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### General System Architecture

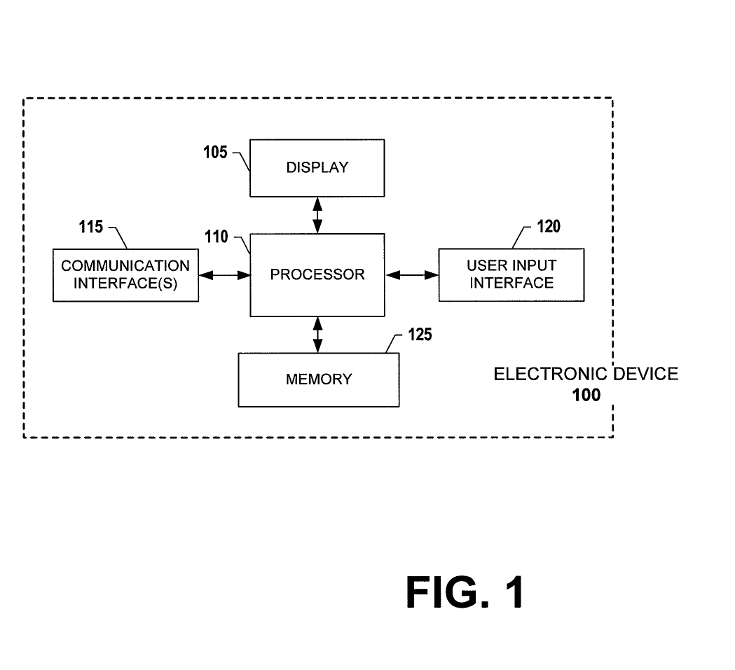

FIG. 1 illustrates a block diagram of an electronic device 100 such as a client, server, computing device (e.g., personal computer (PC), computer workstation, laptop, personal digital assistant, etc.), and/or the like that would benefit from embodiments of the invention. The electronic device 100 may include various means for performing one or more functions in accordance with exemplary embodiments of the invention, including those more particularly shown and described herein. It should be understood, however, that one or more of the devices may include alternative means for performing one or more like functions, without departing from the spirit and scope of the invention. More particularly, for example, as shown in FIG. 1, the electronic device 100 can include a processor 110 connected to a memory 125. The memory can comprise volatile memory and/or non-volatile memory (e.g., removable multimedia memory cards (“MMCs”), secure digital (“SD”) memory cards, Memory Sticks, electrically erasable programmable read-only memory (“EEPROM”), flash memory, or hard disk) and store content, data, and/or the like. For example, the memory may store content transmitted from, and/or received by, the electronic device 100. The memory may be capable of storing data including but not limited to medical data such as medical images (e.g., X-rays) of the human body or one or more parts of the human body as well as diagnoses, opinions, laboratory results, measurements, and/or the like. Thus, some of the diagnoses, opinions, laboratory results, measurements, and/or the like may relate to or be associated with the medical images. The medical images may be in the digital imaging and communications in medicine (“DICOM”) format, and the associated data may conform to the HL7 protocol and may be analyzed and evaluated by the processor 110 of the electronic device 100. In this regard, the processor 110 of the electronic device 100 may properly index, classify, segment, and store the medical images.

Also for example, the memory typically stores client applications, instructions, and/or the like for instructing the processor 110 to perform steps associated with the operation of the electronic device 100 in accordance with embodiments of the present invention. As explained below, for instance, the memory 125 can store one or more client application(s), such as software associated with the generation of medical data as well as handling and processing of one or more medical images.

The electronic device 100 can include one or more logic elements for performing various functions of one or more client application(s). The logic elements performing the functions of one or more client applications can be embodied in an integrated circuit assembly including one or more integrated circuits integral or otherwise in communication with a respective network entity (i.e., computing system, client, server, etc.).

In addition to the memory 125, the processor 110 can also be connected to at least one interface or other means for displaying, transmitting and/or receiving data, content, and/or the like. The interface(s) can include at least one communication interface 115 or other means for transmitting and/or receiving data, content, and/or the like. In this regard, the communication interface 115 may include, for example, an antenna (not shown) and supporting hardware and/or software for enabling communications with a wireless communication network. For instance, the communication interface(s) can include a first communication interface for connecting to a first network, and a second communication interface for connecting to a second network. In this regard, the electronic device 100 may be capable of communicating with other electronic devices over various wired and/or wireless networks, such as a Local Area Network (“LAN”), Wide Area Network (“WAN”), Wireless Wide Area Network (“WWAN”), the Internet, and/or the like. This communication may be via the same or different wired or wireless networks (or a combination of wired and wireless networks), as discussed above. With respect to wired networks, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the electronic device 100 may be configured to communicate via wireless external communication networks using any of a variety of protocols, such as 802.11, general packet radio service (“GPRS”), wideband code division multiple access (“W-CDMA”), any of a number of second-generation (“2G”) communication protocols, third-generation (“3G”) communication protocols, and/or the like. Via these communication standards and protocols, the electronic device 100 can communicate with the various other electronic entities. The electronic device 100 can also download changes, add-ons, and updates, for instance, to its firmware, software (e.g., modules), and operating system. For example, the electronic device 100 may be in communication with various medical imaging devices/systems and/or health care-related devices/systems.

In addition to the communication interface(s) 115, the interface(s) can also include at least one user interface that can include one or more earphones and/or speakers, a display 105, and/or a user input interface 120. The display 105 may be capable of displaying information including but not limited to medical data. In this regard, the display 105 can be capable of showing one or more medical images which may consist of images or x-rays of the human body or one or more parts thereof as well as the results of diagnoses, medical opinions, medical tests, and/or any other suitable data. The user input interface 120, in turn, may include any of a number of devices allowing the electronic device 100 to receive data from a user, such as a microphone, a keypad, keyboard, a touch display, a joystick, image capture device, pointing device (e.g., mouse), stylus or other input device. By using the user input interface 120, a health care professional may provide notes, measurements, segmentations, anatomical feature enhancements, and/or annotations on the medical images (for example in the DICOM format). For instance, the user input interface 120 may be used to help identify the anatomical parts (e.g., lungs, heart, etc.) of the human body that are shown in medical images.

Also, as will be appreciated by one of ordinary skill in the art, one or more of the electronic device 100 components may be located geographically remotely from the other electronic device 100 components. Furthermore, one or more of the components of the electronic device 100 may be combined within or distributed via other systems or computing devices to perform the functions described herein. Similarly, the described architectures are provided for illustrative purposes only and are not limiting to the various embodiments. The functionality, interaction, and operations executed by the electronic device 100 discussed above and shown in FIG. 1, in accordance with various embodiments of the present invention, are described in the following sections.

### General System Operation

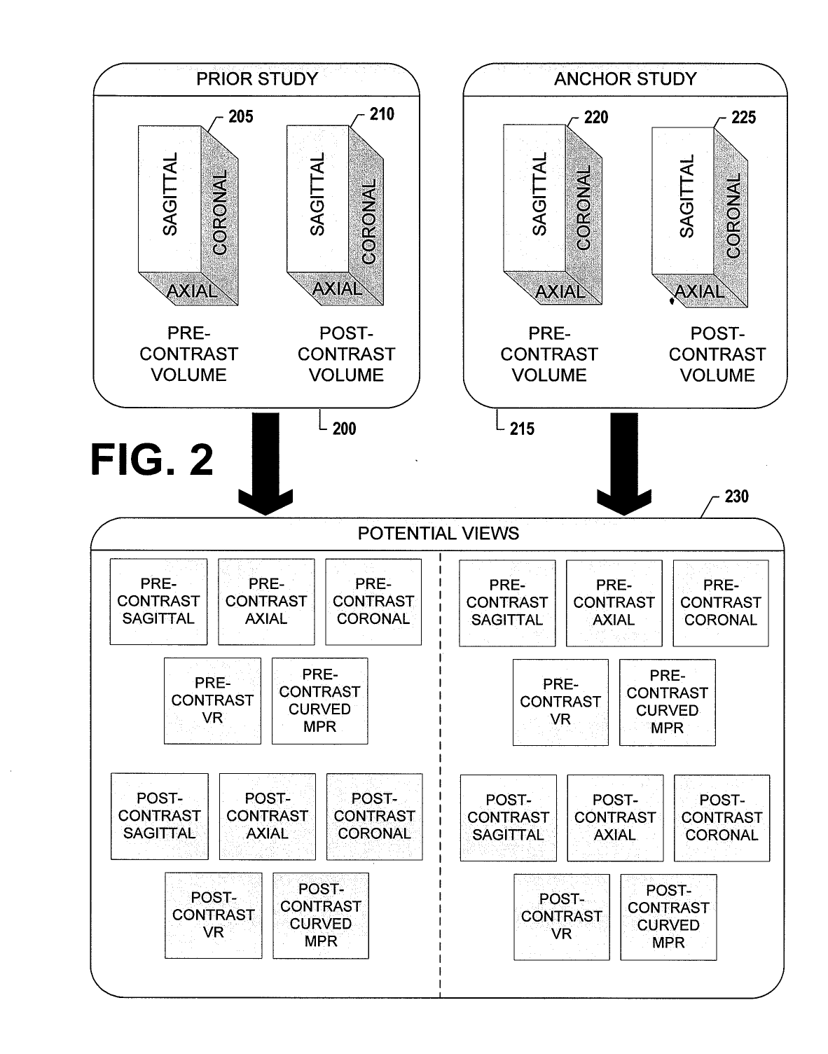

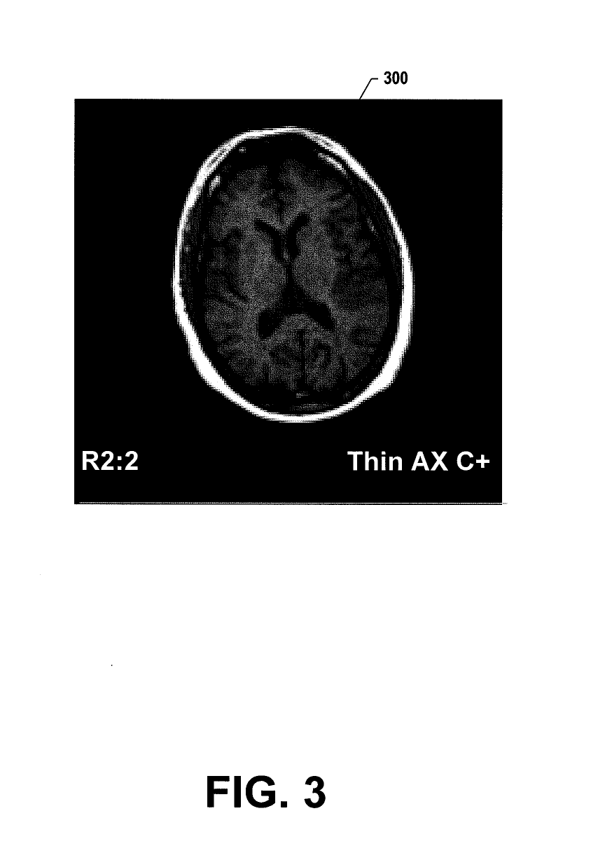

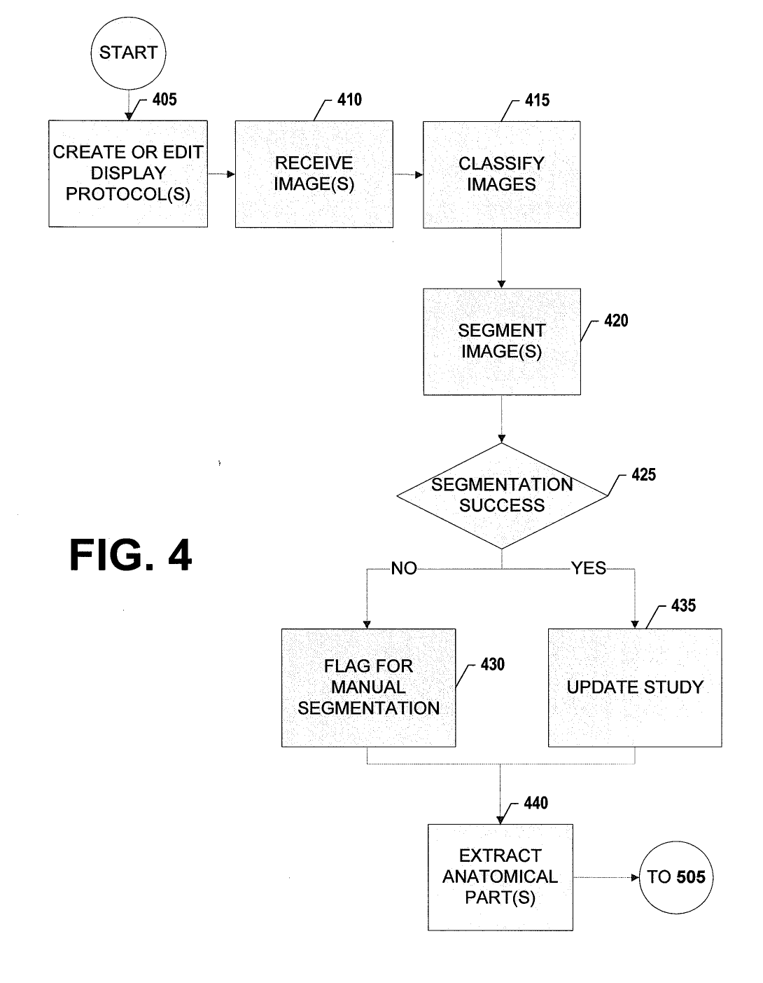

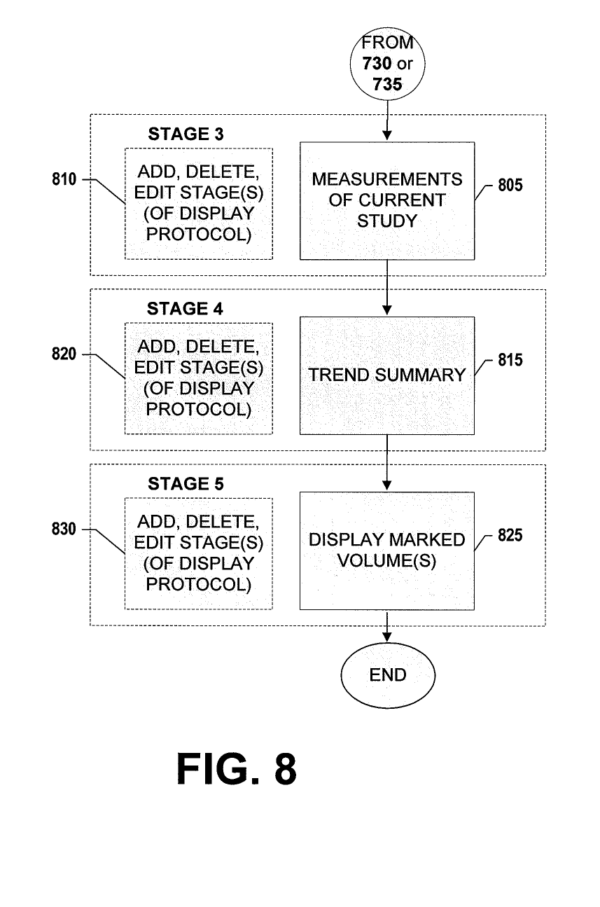

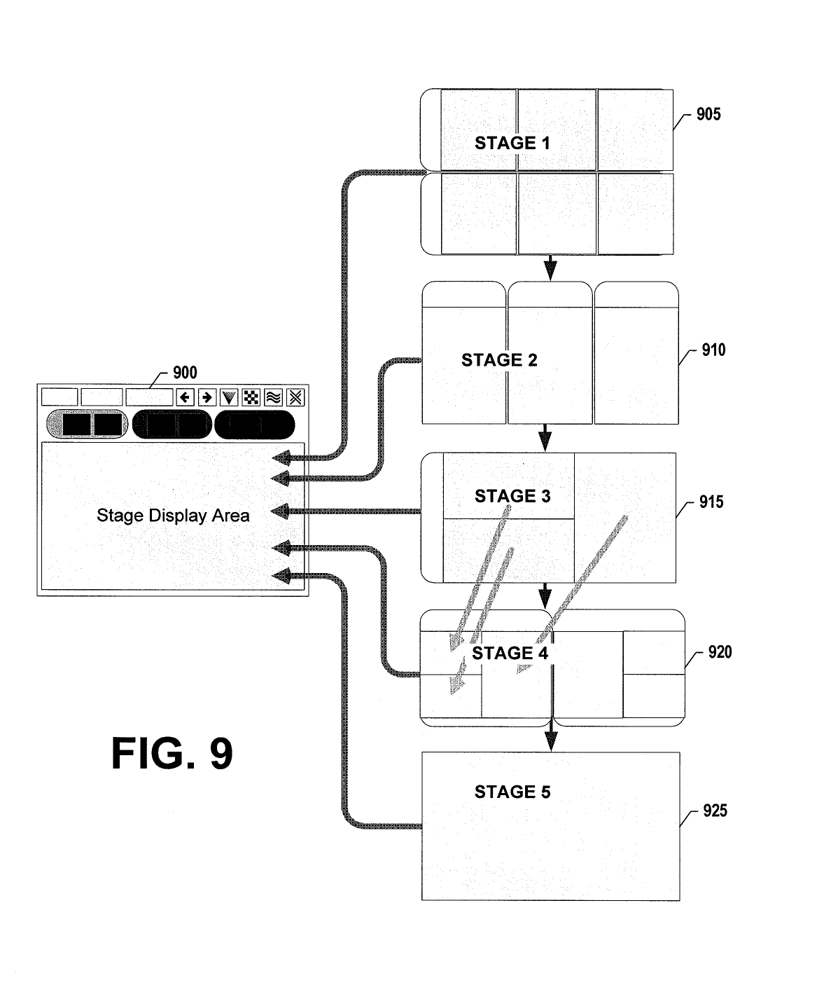

Reference will now be made to FIGS. 2-12. FIG. 2 provides examples of the types of images and studies that can be used with the present invention, and FIG. 3 provides an exemplary image. FIGS. 4-12 provide examples of operations and input and output produced by various embodiments of the present invention. In particular, FIGS. 4-8 provide flowcharts illustrating operations that may be performed to navigate, analyze, annotate, and interpret various images, e.g., medical images of the human body or one or more parts of the human body. Some of these operations will be described in conjunction with FIGS. 9-12, which illustrate input and output that may be produced by carrying out selected operations described in relation to FIGS. 4-8.

The term “image” is used generically to refer to a variety of images that can be generated from various imaging techniques and processes. The imaging techniques and processes may include, for instance, fluoroscopy, magnetic resonance imaging (“MRI”), photoacoustic imaging, positron emission tomography (PET), projection radiography, computed axial tomography (“CT scan”), and ultrasound. The images generated from these imaging techniques and processes may be used for clinical purposes (e.g., for conducting a medical examination and diagnosis) or scientific purposes (e.g., for studying the human anatomy). As indicated, the images can be of a human body or one or more parts of the human body, but the images can also be of other organisms or objects. A “volume of images” or “volume” refers to a sequence of images that can be spatially related and assembled into a rectilinear block representing a 3-dimensional (“3D”) region of patient anatomy. The term “study” refers to one or more images or volumes generated at a particular point in time. In that regard, an “anchor study” refers to a main study of interest. And a “prior study” (study 200 of FIG. 2) may include one or more images or volumes generated before the one or more images or volumes of the anchor study (study 215 of FIG. 2). By using multiple studies, in one embodiment, the studies (e.g., one more volumes, used interchangeably throughout) can be used to aid medical professionals in diagnosing, monitoring, and otherwise evaluating a patient's medical condition over time.

In addition to the range of imaging techniques and processes, there may be a variety of views for each type of volume as shown in the potential views of FIG. 2 (views 230). The different views of the volume may include views along the original axis of image acquisition (e.g., axial to the patient's body), multi-planar reconstruction (“MPR”) views orthogonal to this axis (e.g., sagittal and coronal to the patient's body), and specialty reconstructions such as volume rendering (“VR” generically refers to a two-dimensional (“2D”) projection used to visualize volumes in an anatomically realistic manner). Additionally, a study may contain multiple types of volumes. For example, a study may contain a volume acquired prior to injection of a contrast medium/agent and a volume acquired at a time point after injection of a contrast medium/agent. Thus, the term “pre-contrast” is used generically to refer to images that do not include views of the contrast medium/agent (e.g., iodine or sugar) that has been introduced, for example, into a patient. And the term “post-contrast” refers to images that include views of the contrast medium/agent, for instance, that has been introduced to the patient. Thus, the possible views for such a two-volume study may include pre-contrast axial, pre-contrast sagittal MPR, pre-contrast coronal MPR, pre-contrast VR, post-contrast axial, post-contrast sagittal MPR, post-contrast coronal MPR, and post-contrast VR. This ignores additional combinations resulting from the need for oblique rather than orthogonal angle MPRs and different reconstruction slab thicknesses and projection algorithms, e.g., maximum intensity projection (“MIP”), minimum intensity projection (“mIP”), and average intensity projection (“avIP”). Furthermore, in addition to the common flat MPR, there exist curved MPR view variants appropriate to display curved or tortuous structures in the human body (e.g., the spinal column, vessels, and the colon), which further increases the multiplicity of potential views of the same data required by the user. With the various views, 2D and 3D images can be generated, by combining multiple images, to allow for enhanced viewing of an object such as the heart of a patient (images 205, 210, 220, and 225 of FIG. 2). As will be recognized, though, the above-discussed techniques and processes, types of images, and views are exemplary and not limiting to the embodiments of the invention.

As discussed, images, volumes, and studies can be used to assist medical professionals in diagnosing, monitoring, and otherwise evaluating a patient's medical condition (generally referred to as “interpreting” an image or volume). In interpreting images or volumes, medical professionals may need to navigate, analyze, and annotate multiple images. In some cases, the navigation, analysis, and annotation can be performed automatically (e.g., performed with out human intervention) by the electronic device 100, such as automatically identifying chambers of a heart. However, other steps may require human interaction with the electronic device 100 before the images can be accurately interpreted. Similarly, many of the automatic and/or manual steps performed in interpreting an image or volume of a particular case type may be repeated (or may be similar) each time a medical professional interprets a given case type. For instance, for each heart case involving enlarged atriums, a particular medical professional may want to: (1) view the pre-contrast sagittal view of the heart; (2) identify the chambers of the heart; (3) measure the chambers of the heart; (4) annotate the measurements on the image; (5) and view a 3D volume rendered image of the heart. Comparison with prior studies for identification of pre-existing conditions (as opposed to new conditions) or trend calculations related to on-going treatment may need also to be performed. Because of the repetitive nature of interpretations, efficiency can be increased by using a configurable workflow designed to perform some of the interpretation steps automatically (if possible) and guide a medical professional through the manual steps of interpreting heart case types directed to enlarged atriums.

To that end, as indicated in FIG. 4, a “display protocol” for a particular case type can be created and/or edited (Block 405 of FIG. 4). The term “display protocol” generically refers to a diagnostic flow (executed, for example, by the electronic device 100) that may include automated and/or manual steps to be performed in interpreting the images of a particular case type. Each display protocol may be stored by or otherwise accessible via the electronic device 100 and may comprise one or more “stages.” The term “stage” is used generically to refer to an automated or manual step of a display protocol. Thus, in one embodiment, as part of a display protocol being executed on an electronic device 100, a stage may (1) provide instructions to the user and wait for the user's input before proceeding to a subsequent stage or (2) perform an automatic step of the display protocol without user involvement (e.g., identifying the chambers of the heart). As indicated, the stages of a display protocol may be edited or deleted and new stages may be added. These potential edits, additions, and/or deletions may occur at any time before, during, or after execution of a display protocol. This configurability allows an end user to receive guidance to interpret a particular case type, while still providing the ability to deviate from the defined display protocol by deleting, editing and/or adding stages. Thus, a display protocol comprises a configurable diagnostic flow of one or more editable stages, wherein the stages may include automated and/or manual steps for interpreting images of a particular case type.

The display protocols may come predefined from a manufacturer and/or be created by an end user (or those associated with the end user). That is, in some cases, the display protocols that come predefined from the manufacturer can be executed and/or edited. Similarly, a user can create one or more display protocols (and later edit them). In creating or editing a display protocol, whether before, during, or after execution, the stages may be modified in a variety of ways, such as by (1) copying one or more stages from an existing display protocol, (2) inserting a new blank stage with a specific layout and conditions for execution (e.g., only perform this stage if there are matching criteria in the reference series), (3) setting name and/or guidance text for one or more stages, (4) deleting and/or re-ordering one or more stages, (5) setting criteria for which images and studies should be considered appropriate for display in a given stage, (6) indicating how and where to display the same MPR and VR images of a particular group (e.g., in the same stage and/or linked across stages or of the same volume with different view angles etc.), and (7) changing the layout of how a stage is presented via the display 105.

In either case, for instance, the display protocols can be configured to tailor a reading to a group of colleagues or to guide users through an interpretation of a particular case type. For instance, a department head (e.g., the head of cardiology at a hospital) or a team of cardiologists may create and/or edit a display protocol for all cases involving enlarged atriums. By creating and/or editing a particular display protocol, the cardiologist or team of cardiologists can guide other medical professionals in the way a particular case type should be interpreted. This structured guidance can increase efficiency (reducing the time needed to reach a proper diagnosis or better understand a patient's medical condition) and reduce the time for training and continuing education (allowing infrequent users to employ complex interpretation techniques that would otherwise require extensive training). And as discussed, the display protocols allow the end user the freedom to deviate from the defined stages by deleting, editing, and/or adding stages at any time before, during, and/or after execution. With respect to the particular case types, in one embodiment, the case types may correspond to the respective display protocols. Thus, a user (and/or those associated with the user) may designate the display protocols that are deemed appropriate for the specific case types, for example, via a ranking mechanism. The ranking mechanism may indicate which display protocol(s) is considered as the most favored display protocol (e.g., the default display protocol) and may include alternate display protocols for rarer instances of a particular case type. For instance, each case type may correspond to a heading or subheading within a hierarchy, such as those shown in Table 1. Table 1 provides an illustrative hierarchy of case types that correspond to exemplary display protocols, respectively.

TABLE 1

```
Breast
Chest
Cranium and Contents
Face and Neck
  Stenosis
  Carotid
Gastrointestinal (GI)
Genitourinary (GU)
Heart
  Benign Mass
  Congenital
  Cyst
  Infection
  Non-Infectious Inflammatory Disease
  Trauma
  Vascular
    Aortic Coarctation
    Dilated Cardiomyopathy
    Atrium Enlargement
    Pericardial Effusion
Spine and Peripheral Nervous System
Skeletal System
Vascular/Lymphatic
```

As shown in FIG. 4, before a display protocol is identified and executed, many other steps may be performed, such as various “preprocessing” steps. The term “preprocessing” is used generically to refer to a variety of techniques and processes of automatically editing, formatting, and manipulating images-as described in greater detail below. And although the preprocessing steps are described as being performed by the electronic device 100 for simplicity, the steps may in fact be performed by other devices or manually. For instance, in one embodiment, after defining and/or editing a display protocol, the electronic device 100 can receive the images from a prior study and/or a current study. The images can be received by the electronic device 100 from various medical imaging devices/systems and/or health care-related devices/systems (Block 410). For instance, the images may be received from an MRI machine or from a server located in a physician's office or a hospital's technology center. Alternatively, the images can be retrieved from the memory 125 of the electronic device 100. Irrespective of the source, once the images have been received by the electronic device 100, the images can be classified using a uniform classification scheme/system.

The uniform classification scheme/system for images and volumes can be defined in accordance with a universally accepted classification system (e.g. as defined in the DICOM standard) or an extensible proprietary classification system (Block 415). In either case, the electronic device 100 may determine such attributes as the default view perspective of the volume along the axis of acquisition (e.g., axial, coronal, sagittal), a classification of the acquisition slice thickness (e.g., thick, thin, very thin), the presence of a contrast agent, whether the data is original or derived, and other technical and clinical parameters of use for distinguishing between images and volumes (collectively referred to a “classification attributes”). For example, FIG. 3 indicates that the volume 300 from reference study two, series two (“R2:2”) was acquired from the axial position, post-contrast (the volume labeled “AX C+” in the example). As will be recognized, a variety of classification schemes/systems can be used to classify the volumes and images in a study. In one embodiment, the electronic device 100 can automatically determine the information necessary to classify the images and volumes in a variety of ways. For instance, the electronic device 100 can extract information embedded in the image or volume, such as the date and time generated relative to other volumes in the same study or obtain the default view perspective from the image using extraction algorithms. In addition to or alternatively, the classification of the image(s) may be performed manually via the electronic device 100 in response to receiving input (e.g., via the keyboard, keypad, or pointing device of the user input interface 120) from a user selecting the classification of the image 300 by, for instance, scrolling through various attribute permutation options as shown in FIG. 3. In these embodiments, the electronic device 100 can be used to classify the images into a variety of image classifications, such as pre-contrast axially acquired thin-slice volume, pre-contrast axially acquired derived thick-slice volume, post-contrast axially acquired thin-slice volume, post-contrast derived VR image, and/or the like.

As indicated in Block 420 of FIG. 4, after the images and volumes have been classified, the electronic device 100 may perform automatic segmentation of the volumes and images using a variety of techniques. Generally, the terms “segment” and “segmentation” refer to the process of partitioning a digital image into multiple regions and/or identifying/locating objects and/or boundaries (e.g., lines, curves, etc.) in the image. For example, using various segmentation algorithms, a heart of a patient may be automatically identified and labeled with annotations (e.g., labeling the heart and providing its measurements) in an image by the electronic device 100. Similarly, segmentation may be used to identify all of the anatomical parts in the image, e.g., heart, lungs, and spine. If the electronic device 100 correctly segments the image(s), the electronic device 100 may then update the study with the segmentation information (Blocks 425 and 435). The segmentation information may provide, for example, measurements, feature identification, or simply partition the image into regions. If, however, the electronic device 100 is unable to correctly segment the image(s) (and the algorithm is capable of self-detecting failures), the electronic device 100 can flag (e.g., change an indicator bit representing successful or unsuccessful segmentation) the image(s) for manual segmentation. In addition to self-detected failure, segmentation failure may be indicated manually by the user during visual inspection of the results. In either even, in one embodiment, a display protocol can later be used to perform manual segmentation of an image or study, if necessary (Blocks 425 and 430). Segmentation may fail for numerous reasons, including abnormal anatomy, previous surgery in the segmented region, and/or poor image quality.

As indicated in Block 440, the electronic device 100 may then perform feature “extraction.” The term “extraction” is used generally to refer to providing detailed information regarding an anatomical part (or parts) that may have been identified during segmentation. For instance, during segmentation, the electronic device 100 may identify the heart and lungs of a patient, and, during feature extraction for a case type involving enlarged atriums, the electronic device 100 may identify the chambers of the heart, label them, and provide annotations (e.g., size measurements of the chambers) proximate to the chambers of the heart. Thus, in one embodiment, the segmentation may identify the heart and other body parts, and feature extraction may identify the chambers (and/or other parts) of the heart. As will also be recognized, segmentation and extraction can be performed as a single step or as multiple steps. In either event, if the feature extraction is successful, the electronic device can update the study with the extraction information (Blocks 505 and 515). If, however, automatic extraction fails in a fashion detectable to the algorithm employed, the electronic device 100 can flag the image for manual extraction that may occur later via a display protocol (Blocks 505 and 510). In addition to self-detected failure, automatic extraction failure may be indicated manually by the user during visual inspection of the results.

In addition to segmentation and extraction, two or more studies can be “registered” via the electronic device 100 (Block 520). The term “register” generally refers to identifying one or more anatomical features of interest, such as a feature that has been segmented and/or extracted, from at least two independently acquired volumes (e.g., from one or more prior studies and the anchor study). Once special congruence between these anatomical features of interest is done, a geometric transformation mapping the spatial relationship between the two volumes may be computed, thus allowing direct comparison of the volumes. For instance, an image of a patient's heart that has been segmented and/or extracted from two or more studies can be presented via the display 105 of the electronic device 100. Via registration, the medical professional can view the same region of multiple volumes from the various studies at once. These images can be viewed, for example, side-by-side or superimposed or overlaid on one another. By using registration techniques, medical professionals can monitor and otherwise evaluate a patient's medical condition over time. As should be recognized, registration can occur with two or more studies. If registration is successful, the study can be updated with the registration information (Blocks 525 and 535). If, however, automatic registration fails in a fashion detectable to the algorithm employed, the electronic device 100 can flag the image for manual registration later via a display protocol (Blocks 525 and 530). In addition to self-detected failure, registration failure may be indicated manually by the user during visual inspection of the results.

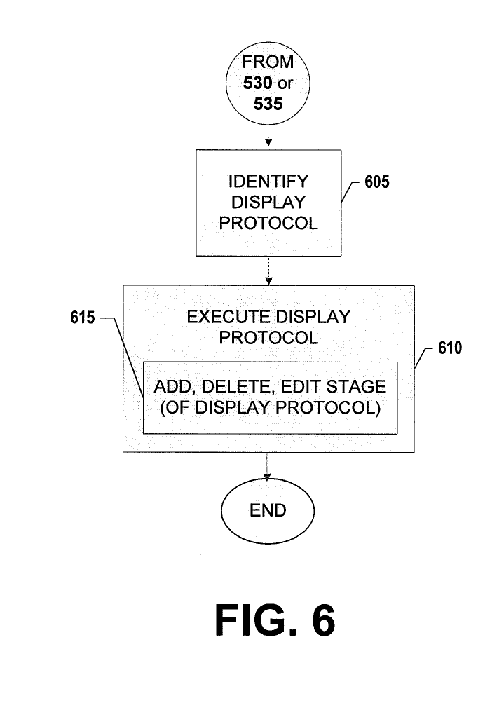

In one embodiment, after the preprocessing has been performed, as shown in FIG. 6, a display protocol can be identified by the electronic device 100 for one or more studies (Block 605 of FIG. 6). This identification can be performed automatically by the electronic device 100 with information obtained during segmentation, extraction, and/or registration. For example, based on the segmentation and extraction of a patient's heart, a general display protocol for hearts may be identified. Similarly, based on the extraction of the chambers of the heart, a display protocol for enlarged atriums may also be identified. If more than one display protocol is identified by the electronic device 100, the user can be presented with the display protocol options to select the appropriate display protocol for execution. Alternatively, selection of a display protocol can be performed manually via input received from the user input interface 120, without an automated component. With respect to the types of display protocols, in one embodiment, the display protocols may correspond directly to case types organized in a hierarchy. For instance, each case type may correspond to a heading or subheading within a hierarchy, such as those shown in Table 1. And the display protocols may directly correspond to the case types shown in each level of the hierarchy. Each display protocol may define reference relevancy rules (“RRR”) which are the criteria by which a subset of other studies belonging to the patient of interest would be considered relevant reference studies. For example, the RRR may utilize a chronology of the studies (e.g., either absolute or relative to the anchor study and other reference studies), type of acquisition device (e.g., CT or MR), case type (e.g., either absolute or matching the anchor study), and body region (e.g., either absolute or relative to either absolute or matching the anchor study).

After a display protocol and relevant reference studies have been identified, the electronic device 100 can execute the identified display protocol (Block 610), which may be edited at any time before, during, and/or after execution (Block 615). In the following paragraphs an illustrative display protocol is described for the purpose of providing a better understanding of the embodiments of the invention.

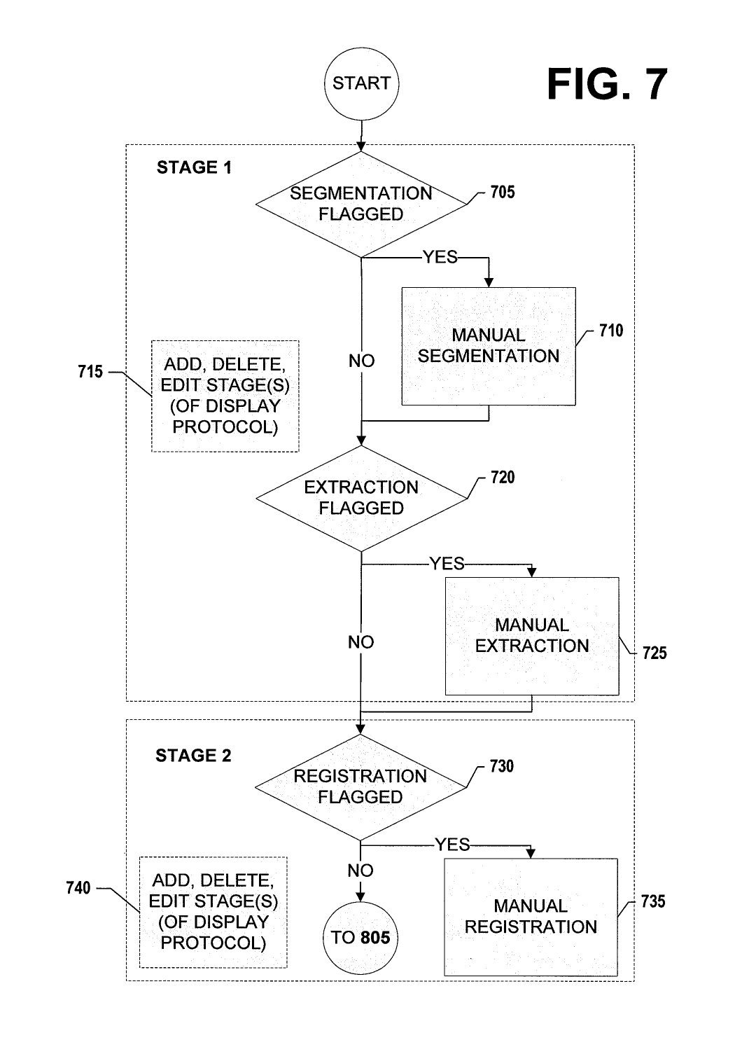

In the present example, as shown in FIGS. 7-12, the display protocol may comprise five stages. The number of stages of the display protocol, however, can vary as can the number of parties using the various stages of the display protocol. For example, a technologist may perform the first two stages of a display protocol, and a physician may perform the last three stages. In such a case, sharing the workload may save the physician time by having the technologist perform part of the display protocol that does not require a skilled physician. This effort can be further aided by providing instructions via the display 105 to guide the user, e.g., a technologist, through the operations that need to be performed for a particular stage.

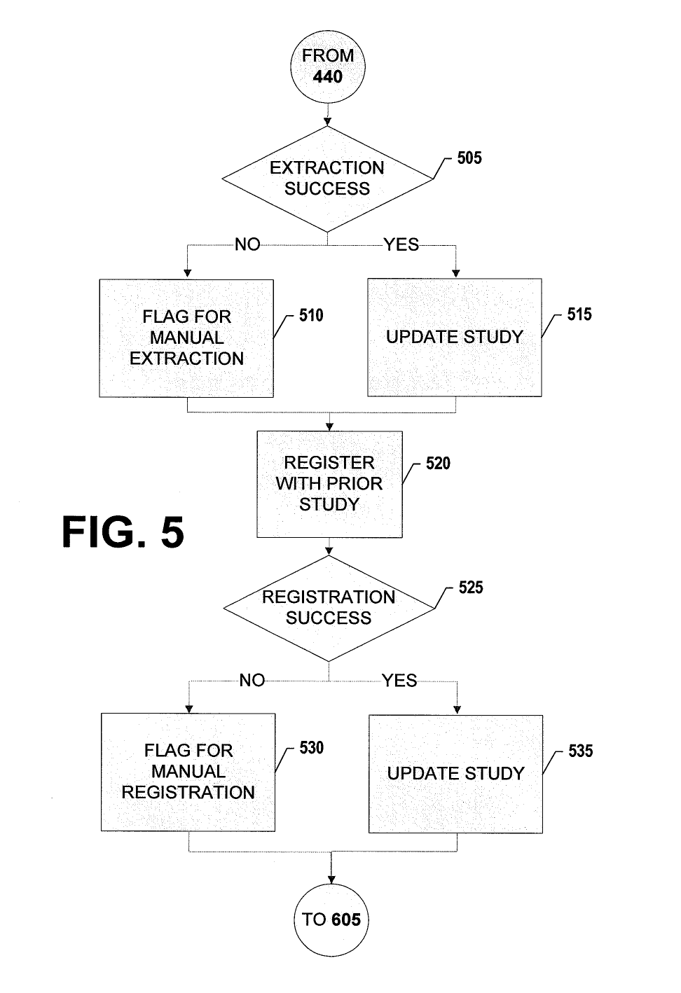

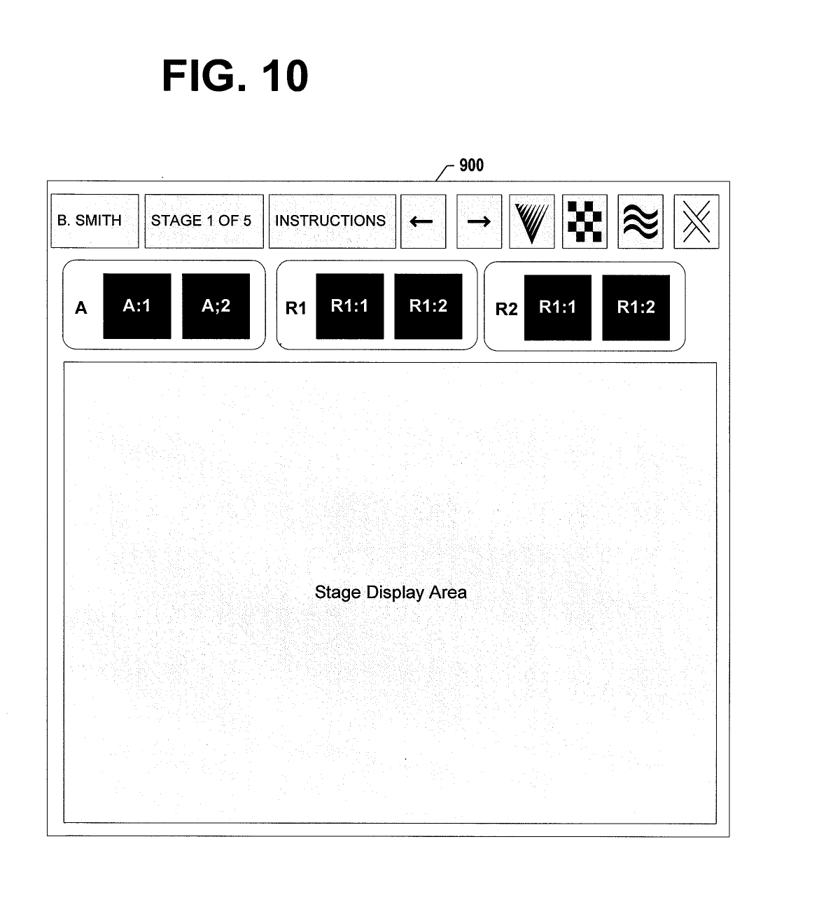

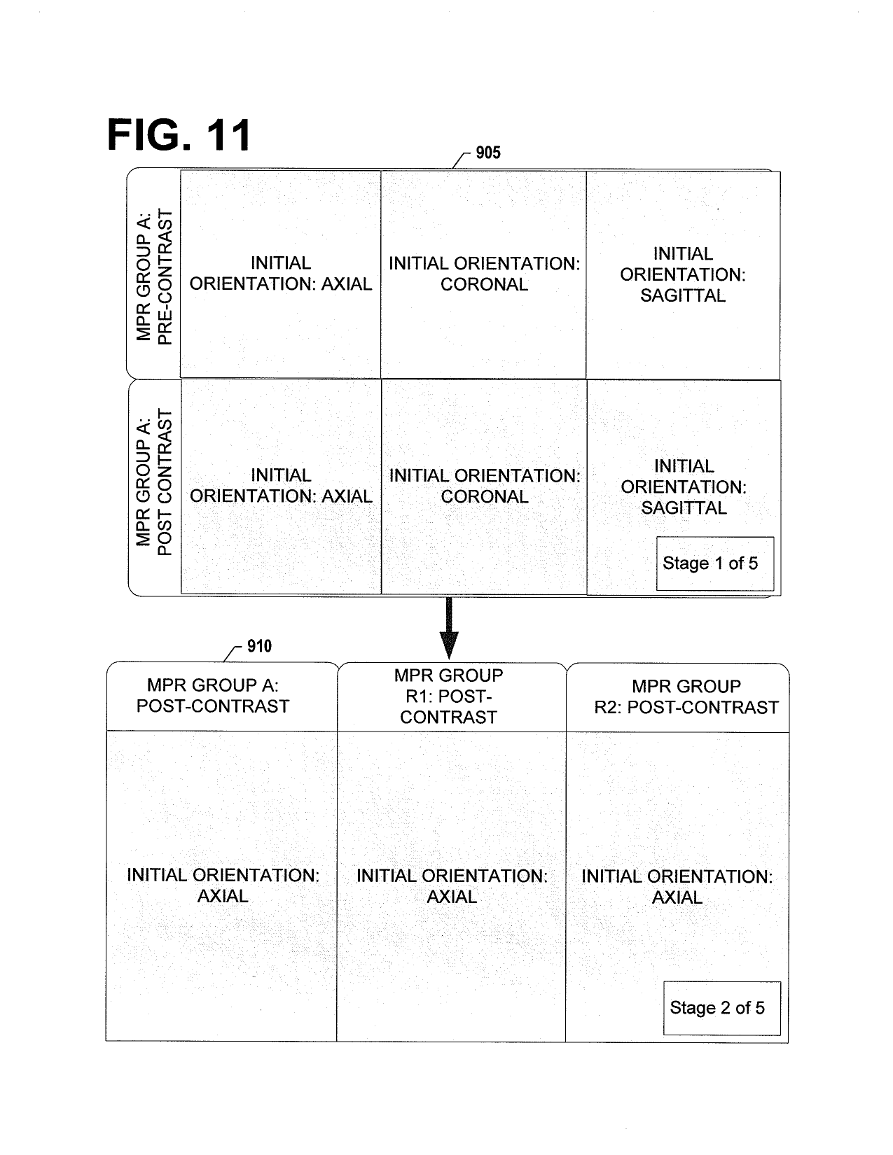

Continuing with the above example, in stage 1 of the display protocol, the electronic device 100 can determine if the segmentation that has been previously performed has been flagged as requiring manual segmentation (as discussed in regard to Blocks 420-435). If manual segmentation has been flagged (Block 705), stage 1 of the display protocol may provide instructions to indicate to the user that manual segmentation needs to be performed and instruct the user how to perform the manual segmentation (Block 710). These instructions may be displayed, for example, via a “pop-up” window or via a menu on a display (as shown in display 900 of FIGS. 9 and 10). Continuing with the above example, as shown in FIG. 11, three pre-contrast images and three post-contrast volumes may be displayed for manual segmentation. To perform the manual segmentation on the images or volumes, a medical professional may utilize a keyboard, keypad, or pointing device (e.g., mouse) of the user input interface 120 to segment the images. In this embodiment, after manual segmentation has occurred or if manual segmentation is unnecessary, the electronic device 100 may determine if the extraction that has been previously performed has been flagged (Block 720) as requiring manual extraction (as discussed in regard to FIGS. 4 and 5). Similar to manual segmentation, stage 1 of the display protocol may provide a display and instructions for the user (e.g., a medical professional) to indicate that manual extraction needs to be performed and instruct the user how to perform the manual extraction (Block 725). In this embodiment, stage 1 can provide for manual segmentation and extraction on one or more images or volumes, such as the three pre-contrast images and the three post-contrast volumes shown in FIG. 11.

In addition to providing for manual segmentation and/or manual extraction, stage 1 (or other stages) of the display protocol can be edited (or even skipped) at any time (Block 715). For example, stage 1 may be edited to display images other than the initial axial, coronal, and sagittal images shown in display 905 of FIGS. 9 and 11. For instance, if the medical professional determines that certain images, volumes, or views are not relevant to interpret a particular case type, she could modify the stage of the display protocol to, for example, change which images are displayed. Additional edits to the display protocol may, for example, include: (1) copying one or more stages from an existing display protocol; (2) inserting a new blank stage with a specific layout and conditions for execution (e.g., only perform this stage if there are matching criteria in the reference series); (3) setting name and/or guidance text/instructions for one or more stages; (4) deleting and/or re-ordering one or more stages; (5) setting criteria for which images and studies should be considered appropriate for display in a given stage; (6) indicating how and where to display the same MPR and VR images of a particular study (e.g., in the same stage and/or linked across stages); (7) changing the layout of how a stage is presented via the display 105; (8) changing the contrast of an image(s); (9) displaying an image with a translucent, transparent, or false background; and (10) changing the number of images that are displayed in a stage.

In addition to editing a stage, the medical professional may generate comments, annotations, or measurements that may be super-imposed, overlaid, or placed directly on locations within an image or volume. Overlaying or super-imposing comments, annotations, measurements, and/or the like on the medical volume(s) may enable the medical professional to indicate her findings in a manner that is useful to the patient or other medical professionals who view the volumes. Additionally, the medical professional may want to mark a location within the volumes(s) for a follow-up assessment with annotations and measurements. For instance, if the medical professional finds a nodule that appears to be unusually dense in one or more of the medical volumes, she may take a density measurement and overlay or superimpose the measurement directly on the corresponding location of the volumes(s) and annotate a location within the volume for further follow up. A means of returning the view to a state showing the locations of annotations, measurements, and points of interest within a volume may be provided via small individual “chits” representing each of such locations and placed adjacent to a view showing the volume. As will be recognized, there are a variety of ways to include comments, annotations, or measurements on medical volumes that are within the scope of the embodiments of the invention.

Continuing with the above example, via stage 2 of the display protocol, the electronic device 100 can determine if the registration that has been previously performed has been flagged as requiring manual registration (Block 730). If manual registration has been flagged, stage 2 of the display protocol may provide instructions to indicate to the user that manual registration needs to be performed and instruct the user how to perform the manual registration (Block 735). As discussed above (and as shown in FIG. 11), in one embodiment, the images can be registered by the user and viewed side-by-side or superimposed or overlaid on one another, for example, as shown in the display 910 of FIGS. 9 and 11. This registration allows medical professionals to monitor and otherwise evaluate a patient's medical condition over time. Thus, if manual registration is necessary, the medical professional, via stage 2, can register two or more studies to evaluate a patient's condition. And as discussed with respect to stage 1, stage 2 (or other stages) can be edited (or even skipped) at any time (Block 740). In addition to editing stage 2, the medical professional may generate comments, annotations, or measurements that may be super-imposed, overlaid, or placed directly on the images or volumes at this stage as described with respect to stage 1.

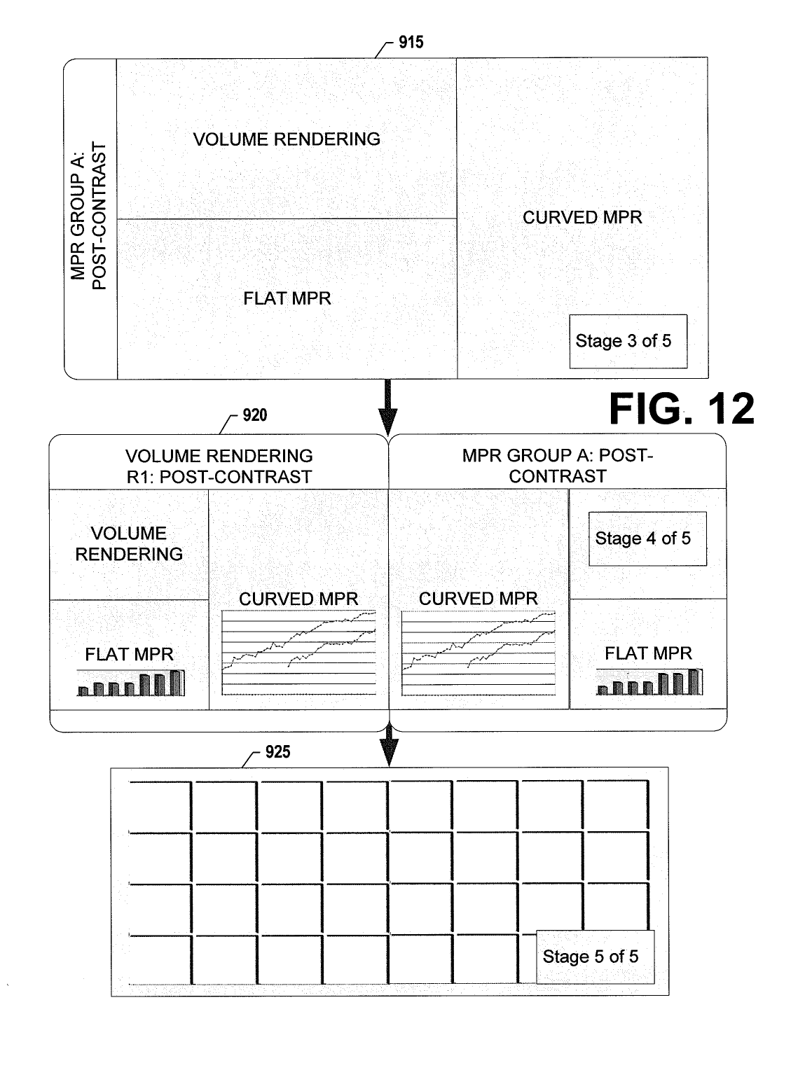

Stage 3 of the display protocol can provide the user with the option to (1) select or choose particular views and/or images or volumes of interest and (2) take measurements of the various images or volumes (Block 805 and display 915 of FIGS. 9 and 12). For instance, in this stage, the user may (1) specify that only post-contrast curved MPRs should be displayed and (2) measure the various chambers of the heart. In short, this stage allows the user to customize the views for the various clinical situations and measure certain features that are relevant to the case type to better understand and interpret the images. This stage can also be edited at any time before, during, or after execution (Block 810). And the medical professional may also generate comments, annotations, or measurements that may be super-imposed, overlaid, or placed directly on the images during this stage.

After stage 3, stage 4 can be executed to view and evaluate various trend summaries and other numerical data related to the patient (Block 815), including data from multiple studies. For example, after measuring the four chambers of the heart in stage 3, the same relevant data can be retrieved from prior studies. With this information, the display protocol can generate graphs or other visual displays to show measurement trends (or other trends) over time (display 920 of FIGS. 9 and 12). By using multiple studies in which measurements of the chambers of the heart have been taken, the medical professional can determine if the patient's condition has deteriorated over time. And as with the other stages, this stage can also be edited at any time before, during, or after execution (Block 820), and the medical professional may also generate comments, annotations, or measurements on the images. In this example, this display protocol may define a synchronized presentation state (using synchronized presentation parameters) between the views of stage 3 (or other stages) and the views comprising “View Group A” of stage 4 (as indicated above, a “group” can comprise multiple views from the same volume, e.g., different angles, windows, and/or the like). Thus, adjustments made to stages during the interpretation steps while using stage 3 can be reflected when the user advances to stage 4. That is, the user does not need to perform the adjustments a second time. Likewise, if the user were to return to stage 3, adjustments made within “View Group A” of stage 4 would be reflected in the corresponding views of stage 3.

In the final stage of the illustrative display protocol, the images that the user has marked (e.g., the images on which she has provided annotations, comments, measurements, or otherwise flagged as being of import) can be displayed to provide an overview of the patient's case (Block 825). Similarly, this stage can be used to provide another medical professional with the ability to view only the marked images after the display protocol has been executed the first time. For instance, a physician desiring to view the “highlights” of a radiologist's report can skip stages 1-4 and only view the marked images in stage 5 (after the radiologist has executed the display protocol). For example, in one embodiment, all images that have been manually marked by a user are displayed in a tiled format (display 925 of FIGS. 9 and 12). In other embodiments, the images may be displayed in a variety of other formats, such as in a coverflow format, a slideshow format, or a split screen format with images from one or more studies. And as will be recognized, this stage can be edited at any time before, during, or after execution (Block 830), and the medical professional may also generate comments, annotations, or measurements on the images during this stage.

As will also be recognized, the described display protocol is exemplary and not limiting to the embodiments of the invention. For example, in one embodiment, the stages of a display protocol may be conditional and/or may branch to other stages (and even branch to alternate display protocols) if certain conditions are met (that may be defined in the respective display protocols). In these embodiments, stages of a display protocol can be added, deleted, or edited at any time before, during, or after execution of the display protocol. And a display protocol may be executed multiple times and the results of each execution saved for review.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
electronically receiving one or more medical volumes corresponding to an anchor study;
electronically classifying each of the one or more volumes corresponding to the anchor study;
electronically identifying, via a computing device, a display protocol from a plurality of display protocols, wherein the display protocol:
comprises one or more stages, and
is configurable to (a) edit, (b) delete, or (c) add one or more stages during execution of the display protocol in response to an input from a user;
electronically executing, via the computing device, the display protocol using at least a portion of the one or more medical volumes corresponding to the anchor study;
causing display of at least a portion of the one or more medical volumes corresponding to the anchor study;
electronically receiving, via the computing device, an input from a user to edit at least one stage of the one or more stages of the display protocol; and
electronically editing, via the computing device, the at least one stage of the one or more stages of the display protocol.

2. A method comprising:
electronically receiving one or more medical volumes corresponding to an anchor study;
electronically identifying, via a computing device, a display protocol from a plurality of display protocols, wherein the display protocol:
comprises one or more stages, and
is configurable to (a) edit, (b) delete, or (c) add one or more stages during execution of the display protocol in response to an input from a user;
electronically executing, via the computing device, the display protocol using at least a portion of the one or more medical volumes corresponding to the anchor study; and
causing display of at least a portion of the one or more medical volumes corresponding to the anchor study.

3. The method of claim 2 further comprising:
electronically receiving, via the computing device, an input from a user to delete at least one stage from the one or more stages of the display protocol; and
electronically deleting, via the computing device, the at least one stage from the one or more stages of the display protocol.

4. The method of claim 2 further comprising:
electronically receiving, via the computing device, an input from a user to edit at least one stage of the one or more stages of the display protocol; and
electronically editing, via the computing device, the at least one stage of the one or more stages of the display protocol.

5. The method of claim 2 further comprising:
electronically receiving, via the computing device, an input from a user to add at least one stage to the one or more stages of the display protocol; and
electronically adding, via the computing device, the at least one stage to the one or more stages of the display protocol.

6. The method of claim 2 further comprising electronically classifying at least one of the one or more medical volumes corresponding to the anchor study.

7. The method of claim 2 further comprising electronically identifying an anatomical part in the one or more medical volumes corresponding to the anchor study.

8. The method of claim 2 further comprising electronically receiving one or more medical volumes corresponding to one or more additional studies based on relevancy criteria defined by the display protocol.

9. The method of claim 8 further comprising:
electronically classifying each of the one or more medical volumes corresponding to the anchor study; and
electronically classifying each of the one or more medical volumes corresponding to the one or more additional studies.

10. The method of claim 9 further comprising:
electronically identifying an anatomical part in the one or more medical volumes corresponding to the anchor study; and
electronically identifying the anatomical part in the one or more medical volumes corresponding to the one or more additional studies.

11. The method of claim 2 further comprising:
electronically identifying an anatomical part in the one or more medical volumes corresponding to the anchor study;
electronically receiving, via the computing device, one or more medical volumes corresponding to one or more additional studies; and
electronically identifying the anatomical part in the one or more medical volumes of the one or more additional studies.

12. The method of claim 2, wherein each stage designates one or more volume views for display based on presentation parameters.

13. The method of claim 2, wherein each stage is further configurable to designate one or more volume views as belonging to one or more groups for display of a medical volume from each group with synchronized presentation parameters.

14. The method of claim 2, wherein each stage is further configurable to designate one or more volume views in the one or more stages as having synchronized presentation parameters.

15. An apparatus, comprising one or more processors configured to:
electronically receive one or more medical images corresponding to an anchor study;
electronically identify a display protocol from a plurality of display protocols, wherein the display protocol:
comprises one or more stages, and
is configurable to (a) edit, (b) delete, or (c) add one or more stages during execution of the display protocol in response to an input from a user;
electronically execute the display protocol using at least a portion of the one or more medical volumes corresponding to the anchor study; and
cause display of at least a portion of the one or more medical volumes corresponding to the anchor study.

16. The apparatus of claim 15, wherein the one or more processors are further configured to:
electronically receive an input from a user to delete at least one stage from the one or more stages of the display protocol; and
electronically delete the at least one stage from the one or more stages of the display protocol.

17. The apparatus of claim 15, wherein the one or more processors are further configured to:
electronically receive an input from a user to edit at least one stage of the one or more stages of the display protocol; and
electronically edit the at least one stage of the one or more stages of the display protocol.

18. The apparatus of claim 15, wherein the one or more processors are further configured to:
electronically receive an input from a user to add at least one stage to the one or more stages of the display protocol; and
electronically add the at least one stage to the one or more stages of the display protocol.

19. The apparatus of claim 15, wherein the one or more processors are further configured to electronically classify each of the one or more medical volumes corresponding to the anchor study.

20. The apparatus of claim 19, wherein the one or more processors are further configured to electronically identify an anatomical part in the one or more medical volumes corresponding to the anchor study.

21. The apparatus of claim 15, wherein the one or more processors are further configured to electronically receive one or more medical images corresponding to one or more additional studies.

22. The apparatus of claim 21, wherein the one or more processors are further configured to:
electronically classify each of the one or more medical volumes corresponding to the anchor study; and
electronically classify each of the one or more medical volumes corresponding to the one or more additional studies.

23. The apparatus of claim 22, wherein the one or more processors are further configured to:
electronically identify an anatomical part in the one or more medical volumes corresponding to the anchor study; and
electronically identify the anatomical part in the one or more medical volumes corresponding to the one or more additional studies.

24. The apparatus of claim 15, wherein the one or more processors are further configured to:
electronically identify an anatomical part in the one or more medical volumes corresponding to the anchor study;
electronically receive one or more medical volumes corresponding to one or more additional studies; and
electronically identify the anatomical part in the one or more medical images corresponding to corresponding to the one or more additional studies.

25. The apparatus of claim 15, wherein each stage is further configurable to designate one or more volume views as belonging to one or more groups for display of a medical volume from each group with synchronized presentation parameters.

26. The apparatus of claim 15, wherein each stage is further configurable to designate one or more volume views in the one or more stages as having synchronized presentation parameters.

27. A computer program product comprising at least one computer-readable storage medium having computer-readable program code portions stored therein, the computer-readable program code portions comprising:
a first executable portion configured to receive one or more medical volumes corresponding to an anchor study;
a second executable portion configured to identify a display protocol from a plurality of display protocols, wherein the display protocol:
comprises one or more stages, and
is configurable to (a) edit, (b) delete, or (c) add one or more stages during execution of the display protocol in response to an input from a user;
a third executable portion configured to execute the display protocol using at least a portion of the one or more medical volumes corresponding to the anchor study; and
a fourth executable portion configured to cause display of at least a portion of the one or more medical volumes corresponding to the anchor study.

28. The computer program product of claim 27 further comprising:
a fifth executable portion configured to receive an input from a user to delete at least one stage from the one or more stages of the display protocol; and
a sixth executable portion configured to delete the at least one stage from the one or more stages of the display protocol.

29. The computer program product of claim 27 further comprising:
a fifth executable portion configured to receive an input from a user to edit at least one stage of the one or more stages of the display protocol; and
a sixth executable portion configured to edit the at least one stage of the one or more stages of the display protocol.

30. The computer program product of claim 27 further comprising:
a fifth executable portion configured to receive an input from a user to add at least one stage to the one or more stages of the display protocol; and
a sixth executable portion configured to edit the at least one stage to the one or more stages of the display protocol.
